(19) United States
(12) Patent Application Publication
(10) Pub. No.: US 2023/0386725 A1
(43) Pub. Date: Nov. 30, 2023

(54) COIL COMPONENT AND ADHESIVE FOR COIL COMPONENT

(71) Applicant: Murata Manufacturing Co., Ltd., Kyoto-fu (JP)

(72) Inventor: Hiroshi MARUSAWA, Nagaokakyo-shi (JP)

(73) Assignee: Murata Manufacturing Co., Ltd., Kyoto-fu (JP)

(21) Appl. No.: 18/447,022

(22) Filed: Aug. 9, 2023

Related U.S. Application Data
(63) Continuation of application No. PCT/JP2022/015622, filed on Mar. 29, 2022.

(30) Foreign Application Priority Data
Apr. 30, 2021 (JP) 2021-077666

(51) Int. Cl. H01F 17/04; H01F 27/29; H01F 27/28; H01F 1/22

(52) U.S. Cl. CPC H01F 17/045; H01F 27/292; H01F 27/2823; H01F 1/22; H01F 2017/048

(57) ABSTRACT

A coil component that suppresses a decrease in adhesion in a magnetic adhesive. The coil component includes a core and a top plate. The core and the top plate are made of magnetic materials. The coil component includes a first wire and a second wire. The first wire and the second wire are wound around the core. The coil component includes an adhesive. The adhesive is interposed between the core and the top plate. The adhesive adheres the core to the top plate. The adhesive includes a thermosetting resin, a metal powder made of a soft magnetic material, and a ferrite powder.

### CROSS-REFERENCE TO RELATED APPLICATIONS

This application claims benefit of priority to International Patent Application No. PCT/JP2022/015622, filed Mar. 29, 2022, and to Japanese Patent Application No. 2021-077666, filed Apr. 30, 2021, the entire contents of each are incorporated herein by reference.

### BACKGROUND

### Technical Field

The present disclosure relates to a coil component and an adhesive for a coil component.

### Background Art

The coil component described in Japanese Unexamined Patent Application Publication No. 2021-19026 includes a core made of a magnetic material and a top plate made of a magnetic material. The core has a columnar winding core portion and flange portions connected to both ends of the winding core portion in an axial direction. The top plate has a plate shape. The top plate is connected to the core so as to connect one flange portion to another flange portion. In the coil component, the top plate and the core are adhered to each other with an adhesive. The adhesive includes a magnetic powder.

### SUMMARY

Since the adhesive disclosed in Japanese Unexamined Patent Application Publication No. 2021-19026 includes a magnetic powder, the adhesive is magnetic as a whole. In order to improve the permeability in the adhesive, it is considered to reduce the average particle diameter of the magnetic powder to increase the ratio of the magnetic powder in the adhesive. However, as the average particle diameter of the magnetic powder is decreased, the possibility of agglomeration of the magnetic powder in the adhesive increases. When the magnetic powder is agglomerated, the adhesion of the adhesive decreases, and thus the core and the top plate that are adhered may be separated from each other.

Accordingly, the present disclosure provides a coil component including a first member made of a magnetic material, a second member made of a magnetic material, a wire wound around the first member, and an adhesive interposed between the first member and the second member and adhering the first member to the second member. The adhesive includes a thermosetting resin, a metal powder made of a soft magnetic material, and a ferrite powder.

In addition, the present disclosure provides an adhesive for a coil component, the adhesive including a thermosetting resin, a metal powder made of a soft magnetic material, and a ferrite powder. According to the above configuration, the ferrite powder agglomerated by a van der Waals force is ground and crushed by a plurality of metal powders. That is, the ferrite powder is disposed while being dispersed in the adhesive. Therefore, the average particle diameter of the ferrite powder can be reduced while a decrease in adhesion of the adhesive is suppressed.

An average particle diameter of a ferrite powder can be reduced while a decrease in adhesion of an adhesive is suppressed.

### BRIEF DESCRIPTION OF THE DRAWINGS

FIG. 1 is a perspective view of a coil component;

FIG. 2 is an exploded perspective view of the coil component;

FIG. 3 is an enlarged view of a part of an adhesive;

FIG. 4 is an enlarged view of a part in FIG. 3; and

FIG. 5 is graph for explaining permeability of the adhesive in which a ratio between a metal powder and a ferrite powder is changed.

### DETAILED DESCRIPTION

### Embodiment of Coil Component

Hereinafter, an embodiment of a coil component will be described. Note that for ease of understanding, components may be enlarged in the figures. The dimensional ratios of the components may differ from the actual ratios or the ratios in the other figures. In addition, the components are hatched in a sectional view, but for ease of understanding, some components are not hatched.

### Overall Configuration

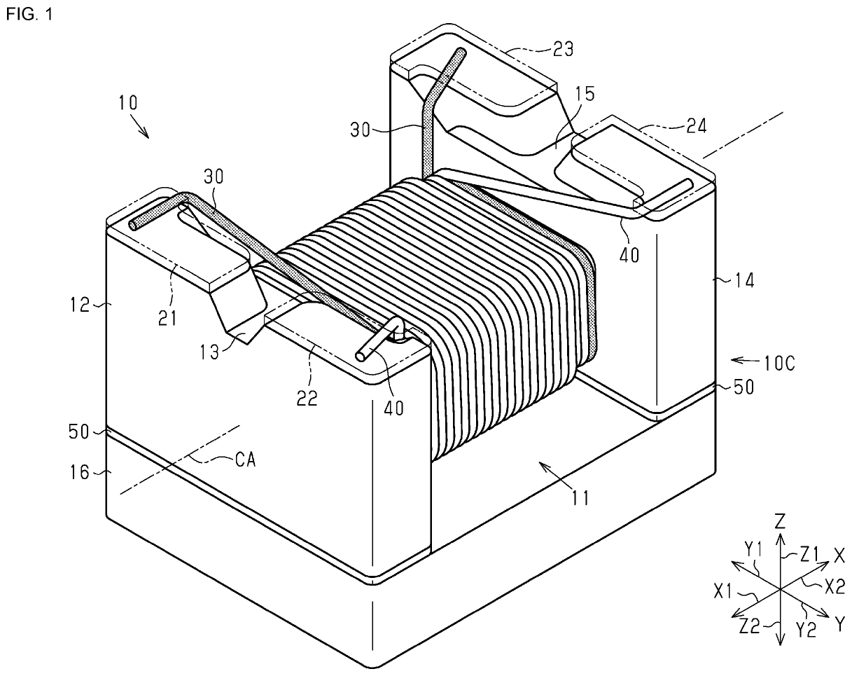

As illustrated in FIG. 1, a coil component 10 includes a core 10C as a first member. The core 10C includes a winding core portion 11, a first flange portion 12, and a second flange portion 14. The winding core portion 11 has a quadrangular prism shape. Therefore, the winding core portion 11 has a central axis CA and extends in a direction along the central axis CA.

Note that in the following description, a first axis X is an axis extending in a direction along the central axis CA. On a cross section orthogonal to the central axis CA of the winding core portion 11, a second axis Y is an axis extending parallel to a specific side among four sides constituting a quadrangular prism, and a third axis Z is an axis orthogonal to both of the central axis CA and the second axis Y. In addition, a first positive direction X1 is one direction along the first axis X, and a first negative direction X2 is another direction along the first axis X. In addition, a second positive direction Y1 is one direction along the second axis Y, and a second negative direction Y2 is another direction along the second axis Y. Moreover, a third positive direction Z1 is one direction along the third axis Z, and a third negative direction Z2 is another direction along the third axis Z.

The first flange portion 12 is connected to a first end, which is an end of the winding core portion 11 in the first positive direction X1. The first flange portion 12 projects outward in a diameter direction centering around the central axis CA when viewed from a peripheral surface of the winding core portion 11.

The first flange portion 12 has a recess 13. The recess 13 is recessed on an end surface of the first flange portion 12 in the third positive direction Z1. The recess 13 is located in the center of the first flange portion 12 in a direction along the second axis Y. The recess 13 is recessed over the entire range of the first flange portion 12 in a direction along the first axis X. Therefore, both end portions of the first flange portion 12 in the direction along the second axis Y have a shape split into two sections with the recess 13 interposed therebetween.

The second flange portion 14 is connected to a second end, which is an end of the winding core portion 11 in the first negative direction X2. The second flange portion 14 has a shape symmetrical to the first flange portion 12 in a direction along the first axis X with the winding core portion 11 interposed therebetween. That is, the second flange portion 14 has a recess 15. The recess 15 is recessed on an end surface of the second flange portion 14 in the third positive direction Z1 and has a shape symmetrical to the recess 13 of the first flange portion 12. In this manner, in the present embodiment, a flange portion is connected to each end in a direction along the central axis CA in the winding core portion 11.

The material of the core 10C is a magnetic material. The material of the core 10C is, for example, a composite material of a magnetic ceramic represented by nickel zinc-based ferrite, a metal magnetic powder, a ceramic powder, and a synthetic resin material, and the like.

The coil component 10 includes a top plate 16 as a second member. The top plate 16 is connected to an end of the core 10C in the third negative direction Z2. The top plate 16 is a plate material having a rectangular shape. The top plate 16 is connected to the core so as to connect an end surface of the first flange portion 12 in the third negative direction Z2 to an end surface of the second flange portion 14 in the third negative direction Z2. The material of the top plate 16 is a non-conductive magnetic material, which is the same as the core 10C. The top plate 16 forms a closed magnetic circuit together with the core 10C. An adhesive for a coil component 50 is interposed between the core 10C and the top plate 16. The adhesive for a coil component 50 connects the core 10C to the top plate 16. Note that in the following description, the adhesive for a coil component 50 is simply referred to as the adhesive 50.

The coil component 10 includes a first terminal electrode 21, a second terminal electrode 22, a third terminal electrode 23, and a fourth terminal electrode 24. The first terminal electrode 21 is located on a surface of the first flange portion 12. Specifically, the first terminal electrode 21 is located in a range on the second positive direction Y1 side when viewed from the recess 13, on the end surface of the first flange portion 12 in the third positive direction Z1.

The second terminal electrode 22 is located on a surface of the first flange portion 12. Specifically, the second terminal electrode 22 is located in a range on the second negative direction Y2 side when viewed from the recess 13, on the end surface of the first flange portion 12 in the third positive direction Z1.

The third terminal electrode 23 is located on a surface of the second flange portion 14. Specifically, the third terminal electrode 23 is located in a range of the second positive direction Y1 side when viewed from the recess 15, on the end surface of the second flange portion 14 in the third positive direction Z1.

The fourth terminal electrode 24 is located on a surface of the second flange portion 14. Specifically, the fourth terminal electrode 24 is located in a range of the second negative direction Y2 side when viewed from the recess 15, on the end surface of the second flange portion 14 in the third positive direction Z1. Note that in the figures, the first terminal electrode 21, the second terminal electrode 22, the third terminal electrode 23, and the fourth terminal electrode 24 are illustrated by two-dot lines.

The above-described first terminal electrode 21 to the fourth terminal electrode 24 are made of a metal layer of silver, copper, or the like and a plating layer of nickel, tin, or the like that is plated on the metal layer. In the present embodiment, the surfaces, in the coil component 10, on which the first terminal electrode 21 to the fourth terminal electrode 24 are provided, face a substrate when the coil component 10 is mounted on the substrate. Note that in the figures, the layer structures of the first terminal electrode 21 to the fourth terminal electrode 24 are not illustrated.

### First Wire and Second Wire

The coil component 10 includes a first wire 30 and a second wire 40. The first wire 30 has a portion that spirally extends on the peripheral surface of the winding core portion 11 around the central axis CA as a rotation axis. The first wire 30 has a circular shape in a sectional view orthogonal to an extending direction of the first wire 30. Note that a part of the portion of the first wire 30 spirally extending is not in contact with the peripheral surface of the winding core portion 11.

As illustrated in FIG. 1, a first end of the first wire 30 is connected to the first terminal electrode 21. One portion including the first end in the first wire 30 extends from the first terminal electrode 21 to a ridge, of four ridges of the winding core portion 11, closest to the second terminal electrode 22.

When the first wire 30 is viewed while facing the first negative direction X2, the first wire 30 is wound around the winding core portion 11 clockwise as going away from the first terminal electrode 21. A portion including a second end on a side opposite to the first end in the extending direction of the first wire 30 extends toward the third terminal electrode 23 from a ridge, of the four ridges of the winding core portion 11, farthest from the fourth terminal electrode 24, near the second flange portion 14 of the winding core portion 11. The second end of the first wire 30 is connected to the third terminal electrode 23.

As illustrated in FIG. 1, the second wire 40 has a portion that spirally extends, around the central axis CA as a rotation axis, in an outer side portion in the diameter direction centering around the central axis CA than is the peripheral surface of the winding core portion 11. The second wire 40 is a wire having the same sectional shape and dimension as the first wire 30. Note that a part of the portion of the second wire 40 spirally extending is not in contact with the first wire 30 and the peripheral surface of the winding core portion 11.

As illustrated in FIG. 1, a first end of the second wire 40 is connected to the second terminal electrode 22. One portion including the first end in the second wire 40 extends toward a ridge, of the four ridges of the winding core portion 11, farthest from the first terminal electrode 21.

When the second wire 40 is viewed while facing the first negative direction X2, the second wire 40 is wound around the winding core portion 11 clockwise as going away from the second terminal electrode 22. A portion including a second end on a side opposite to the first end in an extending direction of the second wire 40 extends toward the fourth terminal electrode 24 from a ridge, of the four ridges of the winding core portion 11, closest to the third terminal electrode 23, near the second flange portion 14 of the winding core portion 11. The second end of the second wire 40 is connected to the fourth terminal electrode 24.

### Adhesive

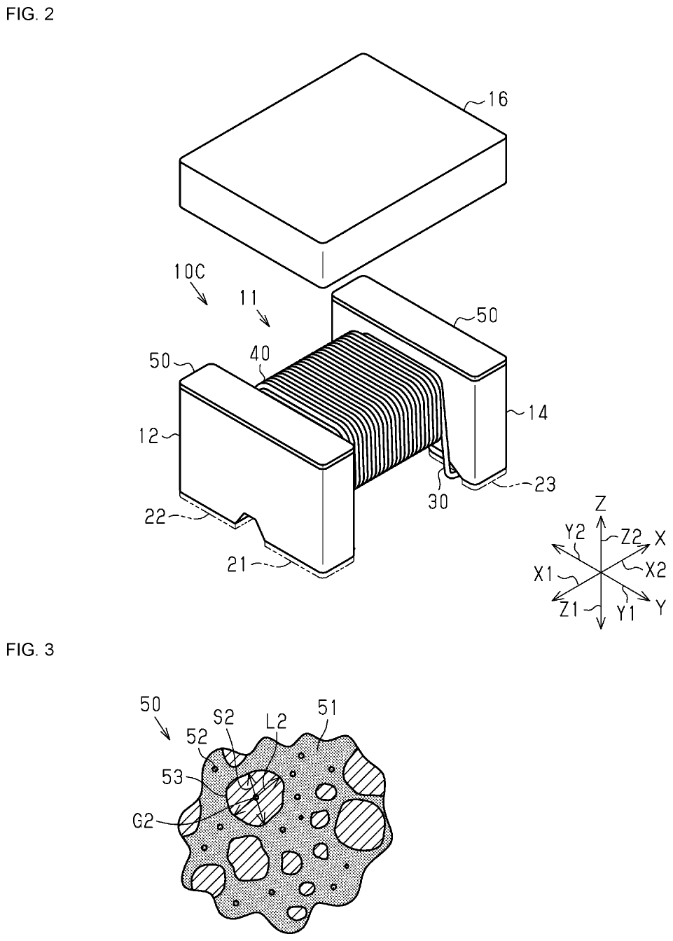

As illustrated in FIG. 2, the adhesive 50 covers the entire surface of the first flange portion 12 facing the third negative direction Z2. In addition, the adhesive 50 connects the first flange portion 12 to the top plate 16 without any gap. Similarly, the adhesive 50 covers the entire surface of the second flange portion 14 facing the third negative direction Z2. The adhesive 50 connects the second flange portion 14 to the top plate 16 without any gap. That is, the top plate 16 is connected to two flange portions.

As illustrated in FIG. 3, the adhesive 50 includes a thermosetting resin 51, a ferrite powder 52, and a metal powder 53 made of a soft magnetic material. The thermosetting resin 51 is, for example, an epoxy resin, a polyimide resin, a phenol resin, an acrylic resin, or a mixture thereof.

In the present embodiment, the ferrite powder 52 is a manganese spinel ferrite oxide. The average particle diameter of particles of the ferrite powder 52 is approximately 0.1 μm. Note that in the present embodiment, the particle diameter of the ferrite powder 52 and the average particle diameter thereof are defined as follows. First, a cross section of the adhesive 50 is viewed. Then, in the sectional shape of the ferrite powder 52 that appears on the cross section, the length of a line that is the longest, of lines that are drawn from an edge to another edge of the sectional shape, is set as the particle diameter of the ferrite powder 52. In addition, the average particle diameter is the average value of particle diameters of the ferrite powder 52 located within a field of view when a cross section of the adhesive 50 is observed by a scanning electron microscope having a magnification of 10,000 times, an acceleration voltage of 5 kV, and five fields of view.

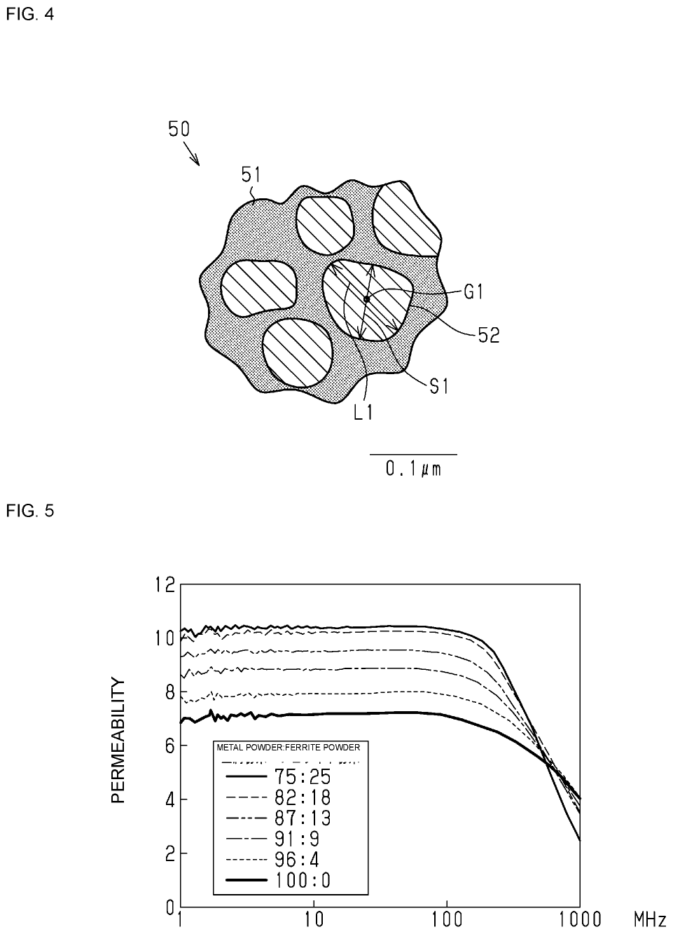

The particle shape of the ferrite powder 52 is substantially spherical. In other words, the ferrite powder 52 has a small aspect ratio in plan view. Specifically, as illustrated in FIG. 4, a cross section of the adhesive 50 is viewed. Then, in the ferrite powder 52 that appears on the cross section, the length of a line that is the longest, of lines that pass through a geometrical center G1 of the sectional shape of one particle and are drawn from an edge to another edge of the sectional shape, is set as a first longest distance L1. In addition, in the sectional shape of the same particle, the length of a line that is the shortest, of the lines that passes through the geometrical center G1 of the sectional shape of one particle and are drawn from an edge to another edge of the sectional shape, is set as a first shortest distance S1. At this time, the value obtained by subtracting the first shortest distance S1 from the first longest distance L1 is equal to or less than 2.

Note that a plurality of particles of the ferrite powder 52 may be agglomerated and form an aggregate. In this case, when an interface between particles can be observed, a portion surrounded by the interface is one particle.

The metal powder 53 is an Fe-based soft magnetic powder. The Fe-based soft magnetic powder is, for example, a crystalline metal powder such as a carbonyl iron powder [Fe(Co)₅], a Sendust magnetic powder [84.5% Fe-10% Si-5.5% Al (wt %)], or a permalloy magnetic powder [Fe50Ni, Fe78.5Ni, or the like]. Note that in the present embodiment, the metal powder 53 is a permalloy magnetic powder [Fe50Ni].

The average particle diameter of particles of the metal powder 53 is approximately 1.5 μm. That is, the average particle diameter of particles of the ferrite powder 52 is smaller than the average particle diameter of particles of the metal powder 53. Note that since the definition of the particle diameter of the metal powder 53 is the same as the definition of the particle diameter of the ferrite powder 52, the description will be omitted. However, the average particle diameter here is the average value of particle diameters of the metal powder 53 located within a field of view when a cross section of the adhesive 50 is observed by a scanning electron microscope having a magnification of 5,000 times, an acceleration voltage of 5 kV, and five fields of view.

The particle shape of the metal powder 53 is substantially spherical. In other words, the metal powder 53 has a small aspect ratio in plan view. Specifically, as illustrated in FIG. 3, a cross section of the adhesive 50 is viewed. Then, in the metal powder 53 that appears on the cross section, the length of a line that is the longest, of lines that pass through a geometrical center G2 of the sectional shape of one particle and are drawn from an edge to another edge of the sectional shape, is set as a second longest distance L2. In addition, in the sectional shape of the same particle, the length of a line that is the shortest, of the lines that passe through the geometrical center G2 and are drawn from an edge to another edge of the sectional shape, is set as a second shortest distance S2. At this time, the value obtained by subtracting the second shortest distance S2 from the second longest distance L2 is equal to or less than 2.

Note that a plurality of particles of the metal powder 53 may be agglomerated and form an aggregate. In this case, when an interface between particles can be observed, a portion surrounded by the interface is one particle.

As illustrated in FIG. 3, the ferrite powder 52 and the metal powder 53 are dispersed in the thermosetting resin 51. The ferrite powder 52 is located between the metal powders 53 and on an outer surface of the respective metal powders 53. In addition, in the present embodiment, the metal powder 53 included in the adhesive 50 is larger than the ferrite powder 52 in the volume ratio.

### Test of Relationship Between Amount of Ferrite Powder and Permeability

In order to examine a relationship between the amount of the ferrite powder 52 and the permeability, six test pieces of the adhesive 50 having different volume ratios between the metal powder 53 and the ferrite powder 52 are manufactured. In the test pieces, the metal powder 53 is a carbonyl iron powder having an average particle diameter of 5 μm. In the test pieces, the ferrite powder 52 is a manganese spinel ferrite having an average particle diameter of 95 nm. In the first test piece, the volume ratio between the metal powder 53 and the ferrite powder 52 is 100:0. In the second test piece, the volume ratio between the metal powder 53 and the ferrite powder 52 is 96:4. In the third test piece, the volume ratio between the metal powder 53 and the ferrite powder 52 is 91:9. In the fourth test piece, the volume ratio between the metal powder 53 and the ferrite powder 52 is 87:13. In the fifth test piece, the volume ratio between the metal powder 53 and the ferrite powder 52 is 82:18. In the sixth test piece, the volume ratio between the metal powder 53 and the ferrite powder 52 is 75:25.

Each test piece has a ring shape and is manufactured by making a sheet of a resin including the metal powder 53 and the ferrite powder 52 having each of the above ratios, and heating and curing the sheet. In addition, the frequency characteristics of the complex permeability in a range of 1 MHz to 1 GHz are evaluated for each test piece. Note that in the following description, a real part in the complex permeability is simply referred to as permeability.

As illustrated in FIG. 5, in a range from 10 MHz to approximately 100 MHz in which a numerical value of the permeability is stabilized, a test piece having a higher ratio of the ferrite powder 52 has higher permeability. Specifically, in the test piece in which the volume ratio between the metal powder 53 and the ferrite powder 52 is 75:25, the permeability indicates approximately 10.2. In the test piece in which the volume ratio between the metal powder 53 and the ferrite powder 52 is 82:18, the permeability indicates approximately 10.1. In the test piece in which the volume ratio between the metal powder 53 and the ferrite powder 52 is 87:13, the permeability indicates approximately 9.5. In the test piece in which the volume ratio between the metal powder 53 and the ferrite powder 52 is 91:9, the permeability indicates approximately 9. In the test piece in which the volume ratio between the metal powder 53 and the ferrite powder 52 is 96:4, the permeability indicates approximately 8. In the test piece in which the volume ratio between the metal powder 53 and the ferrite powder 52 is 100:0, the permeability indicates approximately 7.

As a result, it can be said that as the ratio of the ferrite powder 52 in the resin increases, the permeability increases. On the other hand, as the ratio of the ferrite powder 52 increases, the growth of the permeability decreases. Therefore, when the ratio of the ferrite powder 52 exceeds 25%, even if the ratio of the ferrite powder 52 is increased, it is predicted that the permeability hardly increases.

In addition, when the ferrite powder 52 is included in a resin, the permeability improves compared to a case where the ferrite powder 52 is not included. Therefore, at least, when the volume ratio between the ferrite powder 52 and the metal powder 53 is larger than the state in which the volume ratio between the metal powder 53 and the ferrite powder 52 is 96:4, the permeability significantly improves compared to a case where the ferrite powder 52 is not included.

Note that in the above test pieces, the metal powder 53 is changed from a carbonyl iron powder having an average particle diameter of 5 μm to a permalloy magnetic powder [Fe50Ni] having an average particle diameter of 3 μm, and a test for examining a relationship between the amount of the ferrite powder 52 and the permeability is performed. This test is performed under the same conditions as the above-described test except for the material of the metal powder 53. As a result, even when the metal powder 53 is changed to a permalloy magnetic powder [Fe50Ni] having an average particle diameter of 3 μm, a result having the same tendency as the case where the metal powder 53 is a carbonyl iron powder is obtained.

### Operations of Present Embodiment

The adhesive 50 of the above embodiment includes the metal powder 53 and the ferrite powder 52. Therefore, in a state in which the thermosetting resin 51 is not cured, the same kind of powders, in particular, the ferrite powders 52 having a high van der Waals force attempt to be agglomerated. On the other hand, when each ferrite powder 52 and the metal powder 53 are both mixed, even if the ferrite powder 52 is agglomerated, the agglomerated ferrite powder 52 is ground and crushed by a plurality of the metal powders 53. Therefore, the ferrite powder 52 can be dispersed while not being agglomerated. In this state, when the ferrite powder 52 and each metal powders 53 are mixed in the thermosetting resin 51, the ferrite powder 52 can be located in the adhesive 50 while being dispersed. Note that in a state in which the ferrite powder 52 is mixed in the thermosetting resin 51, the adhesive 50 has very high viscosity, and thus the possibility of re-agglomeration of the ferrite powder 52 is low.

### Advantages of Present Embodiment

(1) In the above embodiment, the adhesive 50 includes the metal powder 53 and the ferrite powder 52. Therefore, when the ferrite powder 52 and the metal powder 53 collide with each other, the agglomerated ferrite powder 52 can be dispersed. As a result, while a decrease in the adhesion of the adhesive 50 is suppressed, the average particle diameter of the ferrite powder 52 can be reduced.

(2) In the above embodiment, the average particle diameter of the ferrite powder 52 is smaller than the average particle diameter of the metal powder 53. According to the magnitude relationship between these particle diameters, the metal powder 53 is likely to suppress agglomeration of the ferrite powder 52. In addition, in the above embodiment, the average particle diameter of the metal powder 53 is equal to or more than ten times the average particle diameter of the ferrite powder 52. When there is such a difference in particle diameter, operation of grinding the ferrite powder 52 by the metal powder 53 becomes remarkable, and thus the ferrite powder 52 is less likely to be agglomerated.

(3) In the above embodiment, the average particle diameter of the metal powder 53 is approximately 1.5 μm. When the average particle diameter of the metal powder 53 is reduced, an increase in thickness of the adhesive 50 in the coil component 10 can be suppressed. As a result, improvement of the characteristics of the coil component 10 can be expected.

(4) In the above embodiment, the average particle diameter of the ferrite powder 52 is approximately 0.1 μm. That is, the average particle diameter of the ferrite powder 52 is substantially smaller than the average particle diameter of the metal powder 53. Therefore, the ferrite powder 52 can be easily located on an outer surface of the metal powder 53 and in a gap between the metal powders 53 adjacent to each other, and the ratio of the ferrite powder 52 in the adhesive 50 can be increased.

(5) The ferrite powder 52 is likely to be magnetized in an extending direction of the first longest distance L1 of the ferrite powder 52. Therefore, as the value obtained by subtracting the first shortest distance S1 from the first longest distance L1 is closer to 1, that is, as the particle shape of the ferrite powder 52 is closer to a spherical shape, there is less deviation in the direction in which magnetization is likely to occur in the ferrite powder 52. In the above embodiment, the value obtained by subtracting the first shortest distance S1 from the first longest distance L1 of one particle in the ferrite powder 52 is equal to or less than 2. Therefore, when the coil component 10 is configured by the adhesive 50 including the ferrite powder 52 described above, the direction in which magnetization is likely to occur is not specified, and thus this configuration is preferred.

(6) In the above embodiment, particles of the ferrite powder 52 are substantially spherical. In addition, particles of the metal powder 53 are substantially spherical. Therefore, in the adhesive 50, the ferrite powder 52 easily enters between the metal powders 53 adjacent to each other, and the filling rate of the ferrite powder 52 and each metal powder 53 in the adhesive 50 is less likely to be decreased.

(7) The metal powder 53 is likely to be magnetized in an extending direction of the second longest distance L2 of the metal powder 53. Therefore, as the value obtained by subtracting the second shortest distance S2 from the second longest distance L2 is closer to 1, that is, as the particle shape of the metal powder 53 is closer to a spherical shape, there is less deviation in the direction in which magnetization is likely to occur in the metal powder 53. In the above embodiment, the value obtained by subtracting the second shortest distance S2 from the second longest distance L2 of one particle in the metal powder 53 is 2 or less. Therefore, when the coil component 10 is configured by the adhesive 50 including the metal powder 53 described above, the direction in which magnetization is likely to occur is not specified, and thus this configuration is preferred.

(8) In the above embodiment, the ferrite powder 52 is a powder of a manganese spinel ferrite oxide. Therefore, a high saturation magnetic flux density is likely to be achieved as the saturation magnetic flux density of the adhesive 50.

(9) In the above embodiment, the metal powder 53 is an Fe-based soft magnetic powder. Specifically, the metal powder 53 is a permalloy magnetic powder [Fe50Ni]. Therefore, high permeability is likely to be achieved as the permeability of the adhesive 50.

(10) In the above embodiment, the coil component 10 has a closed magnetic circuit formed of the core 10C and the top plate 16. In this manner, adopting the adhesive 50 of the above embodiment as the adhesive 50 for adhering the core 10C to the top plate 16 that constitute a closed magnetic circuit is particularly suitable in order to improve the characteristics of the coil component 10 as a whole.

(11) It has been found that from the above test of the relationship between the amount of the ferrite powder 52 and the permeability, as long as the ferrite powder 52 is included in a resin, the permeability of the resin becomes relatively large. In the above embodiment, since the ferrite powder 52 is included in the adhesive 50, high permeability can be correspondingly achieved. Therefore, improvement of the inductance value of the coil component 10 can be expected.

### Modifications

The present embodiment can be implemented by changing as follows. The present embodiment and the following modifications can be implemented mutually in combination in a technically non-contradictive scope.

In the above embodiment, the shape of the winding core portion 11 is not limited to the examples of the above embodiment. For example, the winding core portion 11 may have a columnar shape, or a polygonal prism shape other than a quadrangular prism shape. In the above embodiment, the core 10C may include the winding core portion 11, the first flange portion 12, and the second flange portion 14. For example, the recess 13 and the recess 15 may be omitted. In this case, for example, the first terminal electrode 21 and the second terminal electrode 22 may be separated from each other, and the third terminal electrode 23 and the fourth terminal electrode 24 may be separated from each other.

In the above embodiment, the material and shape of the first terminal electrode 21 to the fourth terminal electrode 24 are not limited to the examples of the above embodiment. For example, the material of the plating layer in the first terminal electrode 21 to the fourth terminal electrode 24 may be an alloy of tin or nickel, or the like. In addition, the first terminal electrode 21 to the fourth terminal electrode 24 do not have to have a plating layer, and a conductive metal layer may be exposed.

The coil component 10 may include only one wire. In the case of this modification, one terminal electrode may exist in the first flange portion 12, and one terminal electrode may exist in the second flange portion 14. The coil component 10 is not limited to the configuration including the core 10C and the top plate 16. The coil component 10 may have a first member around which a wire is wound and a second member that is connected to the first member with the adhesive 50 interposed therebetween, and the first member and the second member may form a closed magnetic circuit.

In the above embodiment, the average particle diameter of the ferrite powder 52 may be smaller or larger than 0.1 μm. On the other hand, in order to secure a filling rate that is high to some extent as the filling rate of the ferrite powder 52 in the adhesive 50, the average particle diameter of the ferrite powder 52 is preferably equal to or less than 1 μm, and is more preferably equal to or less than 0.1 μm. Moreover, when the average particle diameter of the ferrite powder 52 is equal to or less than 1 μm, and in addition, is equal to or less than 0.1 μm, the ferrite powder 52 becomes a single magnetic domain particle without having a magnetic domain wall. Therefore, the high frequency characteristics of the permeability can be increased. Note that from the view point of handling a powder, the average particle diameter of the ferrite powder 52 is preferably equal to or more than 1 nm.

In the above embodiment, the shape of particles of the ferrite powder 52 is not limited to being spherical. That is, in a particle of the ferrite powder 52, the value obtained by subtracting the first shortest distance S1 from the first longest distance L1 may be larger than 2.

In the above embodiment, the ferrite powder 52 may be an oxide of magnetite, magnesium ferrite, nickel-zinc ferrite, and nickel ferrite as a spinel ferrite magnetic powder. In addition, the ferrite powder 52 may be a magnetoplumbite-type ferrite oxide. In addition, the ferrite powder 52 may have components other than the above as long as the ferrite powder 52 is a magnetic powder including ferrite.

In the above embodiment, the average particle diameter of the metal powder 53 may be smaller or larger than 1.5 μm. On the other hand, in order to secure a filling rate that is high to some extent as the filling rate of the metal powder 53 in the adhesive 50, the average particle diameter of the metal powder 53 is preferably equal to or less than 2.5 μm, and is more preferably equal to or less than 1.5 μm. In addition, in order to disperse the ferrite powder 52 agglomerated in the adhesive 50, the average particle diameter of the metal powder 53 is preferably larger than the average particle diameter of the ferrite powder 52 and is equal to or more than 1 μm.

In the above embodiment, the shape of particles of the metal powder 53 is not limited to being spherical. That is, in a particle of the metal powder 53, the value obtained by subtracting the second shortest distance S2 from the second longest distance L2 may be larger than 2.

In the above embodiment, the material of the metal powder 53 may be a material other than the ones exemplified in the above embodiment. For example, the metal powder 53 may be an Fe—Si—Cr-based metal powder [90.5% Fe-3% Cr-6.5% Si (wt %), 92% Fe-5% Cr-3% Si (wt %), or the like], an Fe—Si metal powder [Fe-45% Si (wt %)], or the like. In addition, the metal powder 53 may be an Fe—Ni-based magnetic metal powder, an Fe—Co-based magnetic metal powder [FeCo] such as permendur, an Fe—Si—B—Nb—Cu-based nanocrystal magnetic metal powder, or the like. In addition, the metal powder 53 may be an Fe—Si—Cr-based, Fe—B—Si-based, and Fe—Si—Cr—B-based amorphous powder. Note that composition ratios of the elements in the materials exemplified in the above embodiment and modifications are merely examples, and even when the elements are referred to as the same kind of metal powders, there may be small differences.

What is claimed is:

1. A coil component comprising:
a first member including a magnetic material;
a second member including a magnetic material;
a wire wound around the first member; and
an adhesive between the first member and the second member and adhering the first member to the second member, wherein
the adhesive includes a thermosetting resin, a metal powder including a soft magnetic material, and a ferrite powder.

2. The coil component according to claim 1, wherein
an average particle diameter of particles of the ferrite powder is smaller than an average particle diameter of particles of the metal powder.

3. The coil component according to claim 1, wherein
an average particle diameter of particles of the ferrite powder is equal to or less than 1 μm.

4. The coil component according to claim 3, wherein
an average particle diameter of particles of the ferrite powder is equal to or less than 0.1 μm.

5. The coil component according to claim 1, wherein
an average particle diameter of particles of the metal powder is from 1 μm to 2.5 μm.

6. The coil component according to claim 5, wherein
an average particle diameter of particles of the metal powder is from 1 μm to 1.5 μm.

7. The coil component according to claim 1, wherein
when a cross section of the adhesive is viewed,
a length of a line that is longest, of lines that pass through a geometrical center of a sectional shape of one particle in the ferrite powder and are drawn from an edge to another edge of the sectional shape of the ferrite powder, is set as a first longest distance,
a length of a line that is shortest, of lines that pass through the geometrical center of the sectional shape of the ferrite powder and are drawn from an edge to another edge of the sectional shape of the ferrite powder, is set as a first shortest distance, and
a value obtained by subtracting the first shortest distance from the first longest distance is equal to or less than 2.

8. The coil component according to claim 1, wherein
when a cross section of the adhesive is viewed,
a length of a line that is longest, of lines that pass through a geometrical center of a sectional shape of one particle in the metal powder and are drawn from an edge to another edge of the sectional shape of the metal powder, is set as a second longest distance,
a length of a line that is shortest, of lines that pass through the geometrical center of the sectional shape of the metal powder and are drawn from an edge to another edge of the sectional shape of the metal powder, is set as a second shortest distance, and
a value obtained by subtracting the second shortest distance from the second longest distance is equal to or less than 2.

9. The coil component according to claim 1, wherein
the ferrite powder is a spinel ferrite oxide or a magnetoplumbite-type ferrite oxide.

10. The coil component according to claim 1, wherein
the metal powder is an Fe-based soft magnetic metal powder.

11. The coil component according to claim 1, wherein
the first member has a columnar winding core portion having a central axis, and flange portions connected to both ends in a direction along the central axis of the winding core portion, and
the second member is connected to the two flange portions with the adhesive interposed between the second member and the two flange portions.

12. The coil component according to claim 2, wherein
an average particle diameter of particles of the metal powder is from 1 μm to 2.5 μm.

13. The coil component according to claim 3, wherein
an average particle diameter of particles of the metal powder is from 1 μm to 2.5 μm.

14. The coil component according to claim 2, wherein
when a cross section of the adhesive is viewed,
a length of a line that is longest, of lines that pass through a geometrical center of a sectional shape of one particle in the ferrite powder and are drawn from an edge to another edge of the sectional shape of the ferrite powder, is set as a first longest distance,
a length of a line that is shortest, of lines that pass through the geometrical center of the sectional shape of the ferrite powder and are drawn from an edge to another edge of the sectional shape of the ferrite powder, is set as a first shortest distance, and
a value obtained by subtracting the first shortest distance from the first longest distance is equal to or less than 2.

15. The coil component according to claim 2, wherein
when a cross section of the adhesive is viewed,
a length of a line that is longest, of lines that pass through a geometrical center of a sectional shape of one particle in the metal powder and are drawn from an edge to another edge of the sectional shape of the metal powder, is set as a second longest distance,
a length of a line that is shortest, of lines that pass through the geometrical center of the sectional shape of the metal powder and are drawn from an edge to another edge of the sectional shape of the metal powder, is set as a second shortest distance, and
a value obtained by subtracting the second shortest distance from the second longest distance is equal to or less than 2.

16. The coil component according to claim 2, wherein
the ferrite powder is a spinel ferrite oxide or a magnetoplumbite-type ferrite oxide.

17. The coil component according to claim 2, wherein
the metal powder is an Fe-based soft magnetic metal powder.

18. The coil component according to claim 2, wherein
the first member has a columnar winding core portion having a central axis, and flange portions connected to both ends in a direction along the central axis of the winding core portion, and
the second member is connected to the two flange portions with the adhesive interposed between the second member and the two flange portions.

19. An adhesive for a coil component, the adhesive comprising:
a thermosetting resin, a metal powder including a soft magnetic material, and a ferrite powder.

20. The adhesive for a coil component according to claim 19, wherein
an average particle diameter of particles of the ferrite powder is smaller than an average particle diameter of particles of the metal powder.
